(19) United States
(12) Patent Application Publication
(10) Pub. No.: US 2013/0199873 A1
(43) Pub. Date: Aug. 8, 2013

(54) Ladder Rail Gutter Clamp Device

(71) Applicant: Shawn Prentice, Billerica, MA (US)

(72) Inventor: Shawn Prentice, Billerica, MA (US)

(21) Appl. No.: 13/738,519

(22) Filed: Jan. 10, 2013

Related U.S. Application Data
(60) Provisional application No. 61/595,954, filed on Feb. 7, 2012.

(51) Int. Cl. E06C 7/48; E06C 7/18

(52) U.S. Cl. CPC E06C 7/486; E06C 7/188
USPC 182/107

(57) ABSTRACT

Disclosed is a ladder railing gutter clamp for securing the railing of an upstanding ladder against the outer flange of a roof gutter. The device comprises an angled clamp having a first railing accepting end and a second gutter insertion end. The first end includes a lateral arm secures around the exterior of a ladder railing and an inward tab to prevent lateral motion, while the second end includes a perpendicular turnscrew support arm. A turnscrew threadably mounts through the support arm and is directed toward the clamp first end. The turnscrew support arm is placed within a gutter for advancing the turnscrew towards the interior surface of a gutter outer flange. A pivotable contact pad having high friction surface is connected to the interior end of the turnscrew, which compresses the gutter flange and the ladder railing towards the clamp first end lateral arm.

### CROSS REFERENCE TO RELATED APPLICATION

This application claims the benefit of U.S. Provisional Application No. 61/595,954 filed on Feb. 7, 2012, entitled “Ladder Security System.” The above identified patent application is herein incorporated by reference in its entirety to provide continuity of disclosure.

### BACKGROUND OF THE INVENTION

### Field of the Invention

The present invention relates to clamping securement means for ladders. More specifically, the present invention pertains to an adjustable clamp that affixes a ladder to the interior of a gutter using a screw mechanism, a ball joint-mounted gutter pad and a means for encircling a ladder rail.

Working along the eave of a building to clean the gutters or to access the roof is an inherently dangerous activity that requires an individual to exercise caution and take adequate safety precautions to prevent accidental falling. Generally these areas are accessed using an extension ladder, which is a compound ladder having twin sets of rails that slide relative to one another before locking into place to provide a longer overall length of ladder. After the ladder is extended it can be positioned against the eave of the roof with the base of the ladder firmly against the ground surface and the parallel set of ladder rails in equal contact with the gutter or roof eave. After positioning, the weight of a user climbing the rungs of the ladder is distributed between the ground contact at one end of the ladder, and the roof contact at the upper part of the ladder. The base of the ladder provides vertical and sliding support, while the upper portion of the ladder bears directly against the roof eave or an extended gutter.

There is inherent drawbacks to this type of ladder support configuration. First, the base of the ladder may slide away from the house, causing the ladder to slide downward and allow an individual to fall to the ground or be stranded on the roof. A second source of danger involves lateral movement of the ladder at its contact point with the roof. Since this contact point is a simple contact, whereby the ladder railings bear into the roof or gutter by the weight of the ladder and a supported person, there is not means by which to support lateral motion or sliding of the rails at the point of contact. Finally, there is not means of preventing the ladder from lifting away from the ladder, in the case where there is insufficient lean angle of the ladder and the ladder is largely upright. An individual's momentum while climbing the ladder or small disturbances along the upper portion of the ladder can introduce the risk of the ladder tipping away from the house and separating from the roof or gutter. Anyone on such an unsupported ladder could be severely injured, along with any other workers in the path of the falling ladder. Some individuals choose to use secondary support means, such as elastic cords or string to hold the ladder in place, but these can be clumsy to install and time consuming, leading to individuals overlooking the need to reinforce the support of the ladder and abandon this safety precaution.

The present invention discloses a clamping means between the rail of a ladder and a roof gutter or exposed support. The device surrounds a majority of a ladder railing via a right angle clamp having an inward facing tab, while the opposing end of the clamp employs a turnscrew mechanism to draw the railing towards a gutter exterior wall. The clamp is tightened to secure the ladder railing and gutter together, preventing lateral sliding, tipping of the ladder away from the gutter and vertical sliding of the ladder in the event the base of the ladder slides away from the house. The device is readily deployed while an individual is climbing the ladder to ensure the ladder stays in place, and the ease of deployment ensures compliance with the additional safety precaution. To remove, the turnscrew is sampled retracted and the clamped removed.

### DESCRIPTION OF THE PRIOR ART

Devices have been disclosed in the prior art that relate to gutter securement devices. These include devices that have been patented and published in patent application publications, and generally relate to various structures for clamping or securing a ladder to a roof gutter or roof eave. The following is a list of devices deemed most relevant to the present disclosure, which are herein described for the purposes of highlighting and differentiating the unique aspects of the present invention, and further highlighting the drawbacks existing in the prior art.

Specifically, U.S. Pat. No. 1,374,060 to Chute discloses a ladder clamp that comprises a single, U-shaped member having an open gutter engagement end and an enclosed ladder rail engagement end. The closed rail engagement end includes a turn screw member for forcing the ladder rail away from the enclosed end and towards the open end. A gutter is placed between the ladder rail and the gutter engagement end, such that the turn screw compresses the rail between the device and the gutter, preventing movement. The structure of the Chute device includes an engagement end having pointed tines that are forced into the interior surface of the gutter. The present invention contemplates a ladder rail securement device having an interior gutter surface pad that is compressed thereagainst, where the pad is mounted to a swivel joint to account for variations in the geometry of the gutter when deployed.

Another such device is U.S. Pat. No. 6,837,338 to Grover, which discloses a ladder safety device that comprises a first and second sliding bar clamp, a tie rod and a first and second ladder rail clamp plate. The sliding bar clamp utilizes a first and second clamp to secure opposing sides of a structure, whereby the structure is compressed between the pair of clamps. The sliding clamps attach to a ladder rail clamp plates affixed along the ladder, which provide a means to support a tie rod that is fed through an open ladder rung. The tie rod compresses the clamp plates together, securing the ladder to the plates, and where the plates are pin-supported by the bar clamps to the gutter. The Grover device relies on an open rung ladder an exposed support being adjacent thereto. The Grover device further supports the ladder offset from a support, such as a gutter or wall. The present invention draws the ladder rails against a gutter and utilizes the bearing of the ladder thereagainst as a means to combat a moment or torque that would otherwise detach the Grover device. Specially, the Grover device provides a pin joint support while the present invention contemplates a clamped ladder support.

U.S. Pat. No. 5,383,533 to Nikula discloses a ladder clamping device comprising a threaded shaft having a swivel joint and ladder railing pad. The threaded member attaches to a sliding clamping bar that slideably engages a gutter attachment clamp positioned within the gutter. The threaded member forces the ladder railing from the outside surface and compresses the rail and gutter exterior lip between the railing pad and the gutter attachment clamp. The gutter attachment clamp includes an angled member to position over a gutter upper edge, while the rail pad includes a singular orthogonal tab to prevent lateral movement in one direction along the gutter. The present invention includes a ladder rail clamp that encircles the ladder rail and prevents lateral movement in either lateral direction along the gutter, while a threaded turn screw mechanism is placed within the gutter and a swivel clamping pad is forced against the gutter interior surface.

Finally, U.S. Pat. No. 3,853,202 to Jarboe discloses a ladder safety device for securing a ladder rail to a gutter or roof eave using a bracket attachment device. The bracket comprises an elongated portion having an enclosable end for attachment around a ladder rail, and a gutter attachment means extending from an opposing end of the bracket. The gutter attachment means includes a downwardly facing fork member adapted to engage one of the spikes by which the roof gutter is attached to the eave of the roof. The spike is a rounded, exposed and encirclable member that the fork member surrounds. A pin closes the open end of the fork around the spike to secure the bracket thereto, and thus the ladder against the gutter. The Jarboe device is limited for locations along an eave that provide an exposed rail or spike for the fork to surround. The present invention provides a bracket having a means to compress a ladder rail and the gutter exterior flange within the bracket interior to compress the assembly together and retain the position of the ladder against the gutter.

The present invention discloses an angle clamp having a ladder railing attachment end and a turnscrew gutter attachment end. The railing attachment end surrounds the exterior portion of a ladder railing while the turnscrew clamps the railing and outer portion of a gutter together via the clamping pressure applied by the turnscrew. It is submitted that the structure of the present invention diverges in design elements from the prior art and consequently it is clear that there is a need in the art for an improvement to existing ladder securement devices. In this regard the instant invention substantially fulfills these needs.

### SUMMARY OF THE INVENTION

In view of the foregoing disadvantages inherent in the known types of ladder securement devices now present in the prior art, the present invention provides a new ladder gutter clamp that can be utilized for providing convenience for the user when securing a ladder to an exposed gutter flange or roof eave support.

It is therefore an object of the present invention to provide a new and improved ladder securement device that has all of the advantages of the prior art and none of the disadvantages.

It is another object of the present invention to provide a ladder gutter clamp device that is adapted to surround one of a ladder's two rails and prevent vertical sliding movement, lateral sliding movement and pull-off movement of the ladder rail with respect to a gutter flange.

Another object of the present invention is to provide a ladder gutter clamp device that is insertable into any open gutter having an outer flange, whereby a pivotable compression pad secures against uneven gutter geometry and is compressed against the interior surface of the gutter flange to secure a ladder rail.

Yet another object of the present invention is to provide a ladder gutter clamp device that is readily deployable and removable from a gutter flange to promote regular and consistent use when climbing a ladder that is otherwise resting against a roof eave or gutter.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of the present invention and a call-out view of the pivotable gutter pad.

FIG. 2 shows another perspective view of the present invention.

FIG. 3 shows another perspective view of the present invention.

FIG. 4 shows a view of the present invention in a working state.

### DETAILED DESCRIPTION OF THE INVENTION

Reference is made herein to the attached drawings. Like reference numerals are used throughout the drawings to depict like or similar elements of the ladder gutter clamp device. For the purposes of presenting a brief and clear description of the present invention, the preferred embodiment will be discussed as used for securing a ladder rail to an exposed gutter flange to prevent unwanted movement while climbing the ladder and accessing the gutter or roof. The figures are intended for representative purposes only and should not be considered to be limiting in any respect.

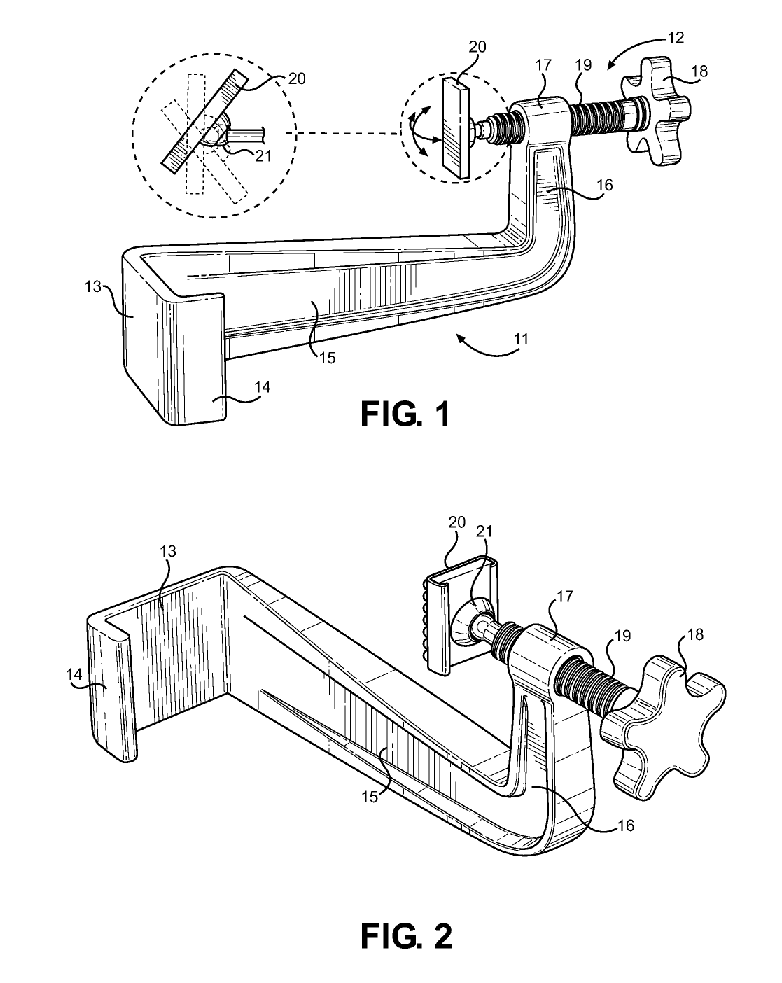

Referring now to FIG. 1, there is shown a perspective view of the ladder gutter clamp of the present invention. The device comprises an elongated clamp 11 having a body region 15, a first end 13 and a second end 16. The first end 13 is adapted to connect about a ladder rail and prevent movement thereof, and comprises a perpendicular arm 13 extending laterally from the body region 15. The body region 13 of the clamp is placed along an interior or exterior long surface of the railing, when considering a railing cross section as a rectangle having a short side adapted to rest against a gutter flange. The lateral arm 13 extending from the body region 15 extends along the outer short side of the railing, preventing pull-off of the ladder rail from a gutter, while an inwardly-directed tab 14 at the distal end of the lateral arm 13 secures around an interior, long side surface of the ladder rail to prevent lateral movement along the gutter in conjunction with the body region 15 of the clamp. This first clamp end, along with the clamp body region 15, secures around a majority if a ladder rail to draw the rail towards the clamp second end 16 when deployed.

The clamp second end 16 is adapted to be placed within an open gutter interior and supply pressure against the gutter exterior flange such that the first end 13 and accompanying ladder rail is drawn thereto using a turnscrew mechanism 12. The second end comprises a perpendicular turnscrew support arm 16 that offsets the turnscrew 12 from the body 15 of the clamp and allows the turnscrew to be inserted within the interior of a gutter. At the distal end 17 of the support arm 16 is a tapped aperture that allows a threaded screw member 19 to be advanced therethrough and to hold the member 19 in a static position. The threaded member 19 includes a first turn knob end 18 and a second gutter compression pad end 20. The turn knob 18 allows a user to advance or retract the screw 19 without tools, while the compression pad 20 is adapted to bear against the interior surface of a gutter flange. This pad 20 is mounted to the threaded member 19 by way of a pivoting ball socket joint or similar pivot joint 21 that allows the pad 20 to be oriented in a number of orientations with respect to the gutter interior surface to account for surface irregularities and the design of the gutter or the orientation of the clamp body 15 when deployed.

Referring now to FIG. 2, there is shown an alternate perspective view of the present invention, wherein the interior portion of the lateral arm 13 and the open space provided between the inward tab 14 and the inner surface of the clamp body 15 is shown. A ladder railing is adapted to consume this volume, whereafter the clamp second end 16 is placed within the gutter interior to advance the compression pad 20 against the gutter outer flange to secure the ladder railing against the gutter outer flange.

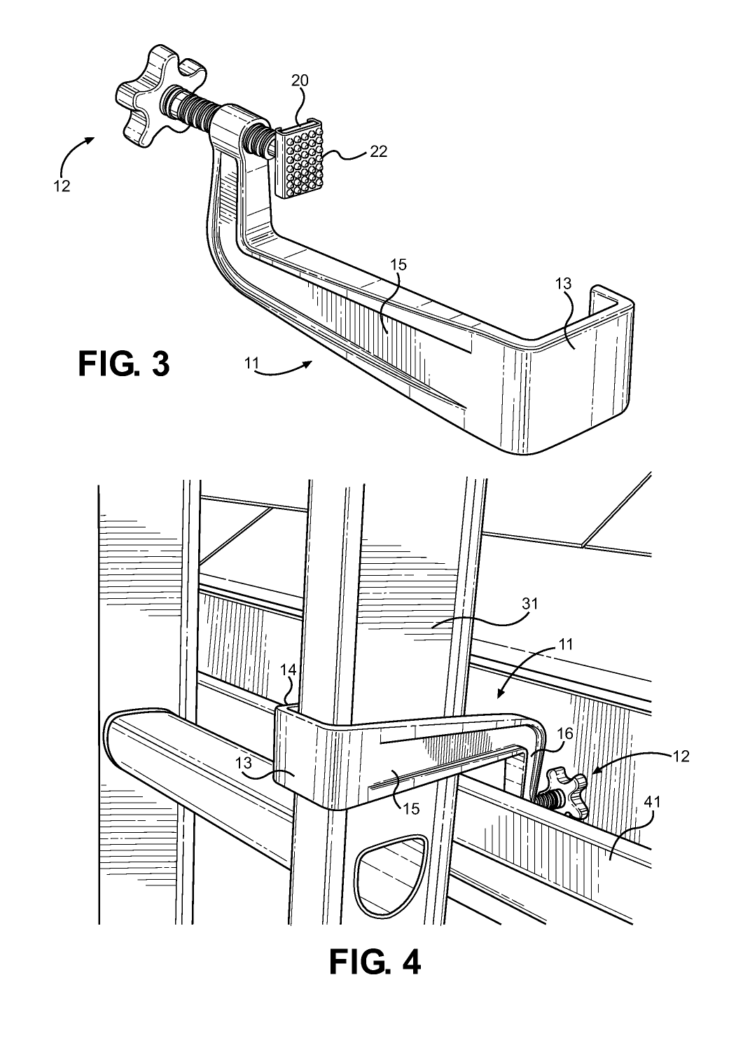

Referring to FIG. 3, the compression pad 20 is shown having a surface texture 22 that increases the pad's grip on the gutter flange when deployed and bearing thereagainst. The texture 22 increases friction at this interface, minimizing slippage in wet conditions or if the turnscrew 12 is not sufficiently tightened to counteract the motion of an individual climbing the attached ladder. The pad 20 can further be a compressible member that deforms as it bears into the gutter, where in conjunction with the ball socket attachment thereof, allows uniform contact across an uneven surface. The pad is oriented appropriately based on the orientation of the clamp 11 and the gutter flange, while the compressible pad 22 deforms to accept any irregularities and maintain a uniform contact interface with the gutter. The force applied by the turnscrew 12 and the compressed material of the pad ensure a high friction contact that resists sliding and therefore movement of the clamp second end within the gutter.

Referring now to FIG. 4, there is shown a view of the present invention in a working state, securing a ladder rail 31 against a gutter flange 41 to eliminate relative movement and increase safety for individuals climb the ladder to access a roof or gutter line. As shown, the body of the clamp 15, the lateral arm 13 and the inward tab 14 deploy across three sides of a ladder rail 31 so that when secured, the clamp 11 prevents sliding and pull-off motion, retaining the original contact point between the rail 31 and the gutter 41 during operation. The downward directed second end 16 of the clamp is inserted into the gutter interior, whereafter the turnscrew 12 is rotated by the user to advance the clamp pad against the gutter outer flange, compressing the gutter flange 41 together with the ladder rail 31. When removal is desired, the pad is simply retracted to release the compression load therebetween.

There are always dangers when working with a ladder along the side of a building or house. The ladder can pull away from the gutter system, slide horizontally from the top, or slide out from the bottom. The present invention comprises a clamping system for a ladder that utilizes a pivoting compression pad and a turnscrew mechanism to secure a ladder rail against a gutter flange. Part of the clamp attaches over top of the side rail of a conventional extension ladder. The pad may include a compressible material, a rigid material, or further include a texture or surface spikes to grip hardened surfaces such as wooden roof eaves. The compressible pad is ideal for uneven, metallic gutters and for making a uniform contact therewith. Overall, the present invention prevents a ladder from moving away from a structure it is being used on, which can potentially injure the user.

It is submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A ladder rail clamp device, comprising:
a clamp having an elongated body, a first end and a second end;
said clamp first end having a perpendicular lateral arm;
said lateral arm distal end having a perpendicular inward tab;
said clamp body, lateral arm and inward tab forming an inner volume to accept a ladder rail therein and secure about three sides of said rail;
said clamp second end comprising a downwardly directed support arm;
said support arm having a distal end forming a tapped aperture to accept a turnscrew therethrough;
said turnscrew comprising a threaded rod having a first end and a second end;
said rod first end having a hand crank member for rotating said rod by hand;
said rod second end having a gutter compression pad pivotably attached thereto.

2) The device of claim 1, wherein said compression pad pivotable attachment comprising a ball and socket joint.

3) The device of claim 1, wherein said compression pad comprises a compressible material.

4) The device of claim 1, wherein said compression pad comprises a textured surface.

5) The device of claim 1, wherein said compression pad comprises a spiked surface.
